(19) United States
(12) Patent Application Publication
(10) Pub. No.: US 2023/0181943 A1
(43) Pub. Date: Jun. 15, 2023

(54) RESPIRATOR MASK FOR LONG-TERM USE

(71) Applicant: OmniMask LLC, Lafayette, CA (US)

(72) Inventors: Marc LURIE, Lafayette, CA (US); Attila VASS, Lafayette, CA (US)

(73) Assignee: OmniMask LLC, Lafayette, CA (US)

(21) Appl. No.: 17/925,900

(22) PCT Filed: May 20, 2021
(86) PCT No.: PCT/US2021/033452

§ 371 Date: Nov. 17, 2022

Related U.S. Application Data
(63) Continuation-in-part of application No. 29/771,847, filed on Feb. 25, 2021.
(60) Provisional application No. 63/027,546, filed on May 20, 2020.
(60) Provisional application No. 63/123,759, filed on Dec. 10, 2020.
(60) Provisional application No. 63/171,885, filed on Apr. 7, 2021.

(51) Int. Cl. A62B 23/02; A62B 18/10; A62B 18/08; B01D 46/42; B01D 46/00

(52) U.S. Cl. CPC A62B 23/02; A62B 18/10; A62B 18/084; B01D 46/4272; B01D 46/0028; B01D 46/0004; B01D 2279/65

(57) ABSTRACT

A respirator mask for long-term use is disclosed. In an example, a respirator mask includes a transparent lens integrated with a frame. The respirator mask also includes a first inhalation filter assembly connected to a left external side of the frame, a second inhalation filter assembly connected to an right external side of the frame, and an exhalation filter assembly connected to a bottom external side of the frame. Each of the filter assemblies have the same dimensions and include filter media, a base section configured o receive the filter media, a filter cap removably connected to the base section to retain the filter media against the base section, and a check valve located between the filter media and the base section or integrated with the base section. The disclosed respirator mask is configured to improve airflow and comfort for a wearer while minimizing postential causes of contamination.

### PRIORITY CLAIM

This application claims priority to and the benefit as a non-provisional application of U.S. Provisional Patent Application No. 63/027,546, filed May 20, 2020, U.S. Provisional Patent Application No. 63/123,759, filed Dec. 10, 2020, and U.S. Provisional Patent Application No. 63/171,885, filed Apr. 7, 2021, the entire contents of which are hereby incorporated by reference and relied upon.

This application also claims priority to U.S. Design Application No. 29/771,847, filed Feb. 25, 2021, the entire contents of which is hereby incorporated by reference and relied upon.

### TECHNICAL FIELD

The present disclosure relates generally to a respirator mask, and in particular to a reusable respirator mask with replaceable filters.

### BACKGROUND

Generally, there are two main types of known filtering respirators. One type is a disposable respirator, which may be used by, for example, a construction worker to mitigate dust inhalation during a short-term sanding operation. The second type is a reusable elastomeric facepiece respirator. These reusable respirators tend to be worn by employees whose occupation regularly exposes them to hazardous materials on a continual basis, such as a chemical engineer in a manufacturing plant. Depending upon the application, each type of mask possesses advantages and disadvantages.

### Disposable Respirator

A primary advantage of a disposable respirator (also referred to as a “mask”) is its inherent sterility and simplicity. For instance, a wearer can quickly deploy a new mask to their face with minimum training to obtain a reasonable amount of protection—at least for a short duration. This disposable nature of the mask means that wearers do not need to be trained. Additionally, processes and facilities do not need to be established for sterilization, maintenance, and safe storage of used masks.

However, disposable masks also possess a number of disadvantages. For instance, disposable masks tend to fit poorly, especially over hard tissue, such as the area around the bridge of a wearer's nose. This in turn causes the loss of an airtight seal around the wearer's face, which allows pathogens and other dangerous particles to bypass filter media and potentially enter the body through the nose or mouth. Published medical research indicates that the loss of an airtight seal can reduce respirator mask effectiveness by up to 90%.

In addition to fitment issues around the bridge of the nose, disposable masks also tend to slide up and down on a wearer's face, especially when the wearer talks. This movement breaks the air seal and also often leads the wearer to use their hand to adjust the mask during or after a conversation—an act which potentially contaminates the surface of the mask. Even trained medical personnel are not immune from this effect. For example, a 2013 study of ten nurses wearing N95 masks found a mean of 14.6 touches to the mask and 6.6 adjustments of the mask on the first day of use. See Physiologic and other effects and compliance with long-term respirator use among medical intensive care unit nurses, Rebmann, Terri et al., American Journal of Infection Control, Volume 41, Issue 12, 1218-1223.

Another issue with disposable masks is the relatively narrow outer edge that forms the airtight seal with the wearer's skin. Even in short periods of less than an hour, these edges tend to generate depressions in the skin of a wearer due to the compression against the face. This in turn causes discomfort for the wearer. Over time, wearers respond to this discomfort by lifting the mask, or at least the edge of the mask, to release temporarily the pressure at the affected area—an action that breaks the air seal and risks transferring viral particles to the interior of the mask and wearer's nose, mouth, and eyes.

Disposable masks are often worn with the straps incorrectly placed. To maximize effectiveness, the lower strap should extend from the mask to the back of the neck and be placed below the ear. The upper strap should travel from the mask to the top rear area of the head and be placed above the ear. However, many users leave both straps down at the neck for convenience or to relieve the pressure on their skin from the edge of the mask. In either case, the air seal is not effectively established and maintained if the mask is not properly secured.

A further disadvantage of disposable masks is flow rate and resistance on inhalation and exhalation. In this context, flow rate refers to the communication of air through single or multiple layers of filter media and is commonly measured in liters per minute (L/min). Resistance refers to the maximum pressure drop during this communication and is usually measured in pascals (Pa). Depending on the mask design as well as industry and/or national standards, one or both values may be different for inhalation versus exhalation. For example, the flow-rate minimum standard for N95 disposable masks is 85 L/min for both inhalation and exhalation. The inhalation resistance standard is <343 Pa and <245 for exhalation. See NIOSH-42C FR84.

However, in real-world use, these standards for “breathability” often leave users feeling short of breath after a few minutes, even during sedentary behavior, such as sitting and reading. Naturally, this discomfort increases with the level of activity as the body requires more oxygen. In the aggregate, these varying levels of discomfort discourage users from wearing masks, or at least wearing them correctly, for prolonged periods of time. Users, even trained users, often react by engaging in non-compliant behavior, such as lifting the mask to take a few quick unrestricted breaths of air.

For similar reasons, disposable masks also tend to suffer from the buildup of excessive heat and humidity, even during moderate activity in mild climates. Although heat radiating from the wearer's face contributes to this problem, the largest factor tends to be heat and humidity introduced into the mask during exhalation. Aside from the obvious discomfort, the heat and humidity tend to cause the generation and pooling of sweat within the mask, which most users describe as extremely uncomfortable. To release the sweat and clear the mask, users will use their (possibly contaminated) hands to lift the mask away from their face and allow the sweat to roll down their face and neck—a process that, again, breaks the air seal and risks contaminating surfaces. Even when the wearer does not clear the mask, the moisture from exhalation tends to build up in and reduce the flow rate of the filter media, which reduces both its effectiveness and lifespan.

To help address exhalation flow rate and the buildup of heat and humidity within the mask, some mask designs include an exhalation value. This type of valve provides a low-pressure route for unfiltered air from the wearer's lungs to communicate outside the mask. Upon exhalation, air from the wearer's lung temporarily increases pressure within the interior of the mask. The air then follows the path of least resistance via the exhalation valve to the lower pressure environment outside the mask.

For most wearers, inclusion of an exhalation valve provides for less restrictive and cooler breathing with less moisture build up inside the faceplate. However, the use of an exhalation valve only helps with mitigation. The exhalation valve does not solve the moisture buildup problem since moisture from the exhaled air still attaches to the interior surface of the filter media, resulting in reduced effectiveness and lifespan.

Inclusion of an unfiltered exhalation valve bears another more significant drawback with regard to pathogenic protection. While an exhalation valve protects a wearer from a contaminated environment, it does not protect the environment (and people in that environment) from a contaminated wearer. Specifically, the valve acts like a chimney that communicates aerosolized particulates from inside the mask into the outside environment. For this reason, the CDC states on its website that disposable masks “with exhalation valves should not be used in situations where a sterile field must be maintained (e.g., during an invasive procedure in an operating or procedure room) because the exhalation valve allows unfiltered exhaled air to escape into the sterile field.” See https://www.cdc.gov/coronavirus/2019-ncov/hcp/respirator-use-faq.html.

Disposable respirators also suffer from a relatively short shelf life before expiration. Respirator manufacturer 3M explains on its website: “The longer a respirator has been in storage, the less likely it is to perform at its full potential. Over time, components such as the strap and nosefoam may degrade, which can affect the quality of the fit and seal.”

The list of disadvantages described above for disposable respirators is representative and not exhaustive. However, most if not all of these issues become more acute in occupations that involve the long-term, continual use of a mask over a full work shift, like a hospital worker, and even more so during non-stop continual use over months, such as by a sailor deployed on a warship.

### Reusable Elastomeric Facepiece Respirator

The second type of respirator is a reusable elastomeric facepiece respirator (“reusable respirator”). Although different manufacturers utilize slightly different terminology in their description, these types of products generally combine an elastomeric facepiece with robust straps and replaceable filter media, usually in the form of a snap- or screw-on cartridge. See, for example, the line of 3M products at https://www.3m.com/3M/en_US/company-us/all-3m-products/?N=5002385+8709322+8711017+8711405+8720539+8720550+3294857497&rt=r3

The main benefit of a reusable respirator is that it provides a much higher degree of comfort against the skin of the wearer and, if worn and used properly, also provides a qualitatively better air seal. Some reusable respirators include both an inhalation valve and an exhalation valve for another advantage. In these products, the inhalation valve closes on exhalation, which redirects exhaled air (with its heat and humidity) away from the filter media and towards the exhalation valve. The result is a cooler mask that provides easier breathability for wearers.

However, reusable respirators also have disadvantages. First, both the respirators and the filter media (cartridges) are far more expensive than disposable respirators. For instance, the cost of a mid-range reusable respirator is up to 100× that of a disposable respirator. The replaceable filters utilized by these masks are also expensive and can cost up to 25× the cost of a disposable respirator.

A second disadvantage is that reusable respirators require significantly more training of the wearer for its protections to be effective. Contamination is a particular risk when doffing a reusable respirator. Wearers also need to learn how to assemble and don according to procedure, how to adjust the straps for fit, how to exchange the filter cartridges, etc. Additionally, complex and multiple parts translate into extended times to don and doff. This issue may reduce wearer availability and may also cause workers to leave jobs early to begin the doffing and cleaning process.

Another disadvantage relates to cleaning. Reusable respirators have to be properly cleaned, which poses additional logistical challenges. Either the wearer or other personnel must be trained for safe handling and cleaning of contaminated equipment. This in turn requires access to cleaning chemicals, cleaning equipment, and facilities (for cleaning and storage) as well as training in and compliance with each manufacturers' defined cleaning processes. The challenges described in the paragraph above becomes especially acute in the context of pathogens. Unlike disposable respirators, reusable respirators contain a number of crevices, seams, angles, and other tight areas that may hold reservoirs of viral particles and other pathogens. As a result, failure to properly clean these types of respirators may yield catastrophic results.

A further disadvantage of reusable respirators is the lack of filtration for the exhaled air. Known reusable respirators are primarily for non-pathogenic industrial use. The lack of a filter for exhaled air is a factor that generates significant risk to others during a pandemic. Specifically, an asymptomatic or pre-symptomatic infected wearer will expel aerosolized particles that can be inhaled by others and/or contaminate surfaces as they eventually land, including skin and clothes of others, as well as tables, door handles, etc.

Another disadvantage of reusable respirators relates to visibility. Known reusable respirators obscure the face of a wearer behind a plurality of layers of plastic and elastomer. The use of opaque plastics means that other persons cannot observe the facial expressions and demeanor of a wearer. Further, due to incorporating thick elastomerics and plastics, reusable respirators tend to significantly distort and dampen the voice of a wearer. This disadvantage requires that the wearer speak slowly and extra loudly to be intelligible, which is an inefficient process that quickly fatigues a wearer.

Although they offer improved fit and comfort and a better air seal than disposable respirators, the significant incremental cost, logistical needs, contamination risk, and poor communication capability of reusable respirators renders these products inappropriate for long-term use in a wide variety of occupations and environments.

### SUMMARY

A respirator mask for long-term use is disclosed herein. The example respirator mask includes a transparent lens that is connected to or otherwise integrally formed with a frame. The user of a transparent lens enables a wearer's facial expressions and mouth movement to be seen by others, which improves social interaction and communication, especially in medical or childcare environments. The respirator mask is configured to be placed over a wearer's nose, cheeks, and chin, thereby providing an air-tight seal. However, the positioning of the respirator mask under a wearer's eyes enables a wearer to have unobstructed vision and improved comfort. The positioning of the respirator mask under a wearer's eyes also enables a wearer to wear their preferred eyewear or prescription glasses without issue.

As described herein, the respirator mask has side sections that are positioned adjacent to a wearer's cheeks. Inhalation filter assemblies are connected to each of the side sections to enable air to be pulled inside of the respirator mask. Air flow from the inhalation filter assemblies to a wearer's nose pulls fresh, cool air across the wearer's face, providing additional comfort. An exhalation filter assembly is connected to a bottom of the respirator mask around a chin area. The downward positioning of the exhalation filter assembly enables accumulated moisture and sweat to be expelled from inside of the respirator assembly. Further, the downward positioning of the exhalation filter assembly pushes expelled air downward instead of outward, thereby preventing possible contamination/infection of other people.

In some embodiments, the exhalation and inhalation filter assemblies have the same shape and dimensions. This enables the same type of filter media to be used for all of the assemblies. As discussed herein, the filter media of the filter assemblies is removable for cleaning or disposable for replacement.

In light of the disclosure herein and without limiting the disclosure in any way, in a first aspect of the present disclosure, which may be combined with any other aspect listed herein, a respirator mask apparatus including a transparent lens integrated with a transparent frame (or a transparent lens that also operates as a frame). The transparent frame includes a top section including a nose bridge to contact a wearer's nose, and left and right sections respectively connected to the top section to contact the wearer's checks. Each of the left and right sections includes at least one aperture. The transparent frame also includes a bottom section including a protrusion to contact the wearer's chin and at least one aperture and an elastomeric lip around a perimeter of the transparent frame configured to provide an air seal with a face of the wearer. The respirator mask apparatus also includes a first inhalation filter assembly connected to an external side of the left section to enclose the at least one aperture, a second inhalation filter assembly connected to an external side of the right section to enclose the at least one aperture, and an exhalation filter assembly connected to an external side of the bottom section to enclose the at least one aperture.

In a second aspect of the present disclosure, which may be combined with any other aspect listed herein, each of the first and second inhalation filter assemblies and the exhalation filter assembly include filter media, a base section configured to receive the filter media, and a filter cap removably connected to the base section to retain the filter media against the base section.

In a third aspect of the present disclosure, which may be combined with any other aspect listed herein, each of the first and second inhalation filter assemblies includes a first check valve facing an inside of the apparatus or integrated with the base section of the respective filter assembly or the respective left or right section, the check valve configured to enable one-way air communication into the apparatus.

In a fourth aspect of the present disclosure, which may be combined with any other aspect listed herein, the exhalation filter assembly includes a second check valve located between the filter media and the bottom section of the frame or integrated with the base section of the exhalation filter assembly or the bottom section of the frame, the check valve configured to enable one-way air communication out of the apparatus.

In a fifth aspect of the present disclosure, which may be combined with any other aspect listed herein, the first and second check valves are reversible or adjustable to change an air-flow direction or air-flow resistance.

In a sixth aspect of the present disclosure, which may be combined with any other aspect listed herein, the filter cap has at least one opening to enable air to pass through to the filter media.

In a seventh aspect of the present disclosure, which may be combined with any other aspect listed herein, each of the filter assemblies are configured to accept different types or sizes of filter media.

In an eighth aspect of the present disclosure, which may be combined with any other aspect listed herein, a first type or size of filter media are used with the first and second inhalation filter assemblies and a second type or size of filter media is used with the exhalation filter assembly.

In a ninth aspect of the present disclosure, which may be combined with any other aspect listed herein, the filter media includes two outer layers configured for structural support and a third inner layer configured for viral and bacterial filtration.

In a tenth aspect of the present disclosure, which may be combined with any other aspect listed herein, at least one of the filter assemblies is replaced by an adaptor that facilitates a connection to at least one of a third-party filter media or a third-party filter assembly.

In an eleventh aspect of the present disclosure, which may be combined with any other aspect listed herein, the positioning of the exhalation filter assembly is configured to enable accumulated moisture and sweat to flow downward out of an inside of the apparatus and enable exhaled air to flow downward preventing external contamination of others.

In a twelfth aspect of the present disclosure, which may be combined with any other aspect listed herein, the transparent lens has a bulbous shape configured to prevent contact between lips and the nose of the wearer.

In a thirteenth aspect of the present disclosure, which may be combined with any other aspect listed herein, the transparent lens includes at least one of dual parallel lenses with an air gap between the lenses or dual parallel lenses with a second lens including a mini-lens located inside of the apparatus.

In a fourteenth aspect of the present disclosure, which may be combined with any other aspect listed herein, the transparent lens has a thickness that is less than 3.0 mm to minimize vocal distortion and decibel loss.

In a fifteenth aspect of the present disclosure, which may be combined with any other aspect listed herein, the transparent lens contains Acoustic Resonant Micro-Surfaces (“ARMS”) that reduce distortion and decibel loss.

In a sixteenth aspect of the present disclosure, which may be combined with any other aspect listed herein, the first inhalation filter assembly is positioned at the left section and the second inhalation filter assembly is positioned at the right section to enable inhaled air to pass over and cool the wearer's face.

In a seventeenth aspect of the present disclosure, which may be combined with any other aspect listed herein, each of the left and right sections includes at least one harness slot to receive a strap of a harness.

In an eighteenth aspect of the present disclosure, which may be combined with any other aspect listed herein, the strap includes ultrasonic welds to enable unused portions of the strap to be removed.

In a nineteenth aspect of the present disclosure, which may be combined with any other aspect listed herein, base sections of the first inhalation filter assembly, the second inhalation filter assembly, and the exhalation filter assembly have the same dimensions to enable interchangeability or removal of check valves.

In a twentieth aspect of the present disclosure, which may be combined with any other aspect listed herein, the top section is configured to sit below a wearer's eyewear.

In a twenty-first aspect of the present disclosure, which may be combined with any other aspect listed herein, a respirator mask apparatus includes a transparent lens integrated with a frame. The frame includes a top section including a nose bridge to contact a wearer's nose, left and right sections respectively connected to the top section to contact the wearer's checks, each of the left and right sections including at least one aperture, and a bottom section including a protrusion to contact the wearer's chin and at least one aperture. The apparatus also includes a first inhalation filter assembly connected to an external side of the left section to enclose the at least one aperture, a second inhalation filter assembly connected to an external side of the right section to enclose the at least one aperture, and an exhalation filter assembly connected to an external side of the bottom section to enclose the at least one aperture. Each of the first and second inhalation filter assemblies and the exhalation filter assembly include filter media, a base section configured to receive the filter media, a filter cap removably connected to the base section to retain the filter media against the base section, and a check valve located between the filter media and the base section or integrated with the base section.

In a twenty-second aspect of the present disclosure, any of the structure and functionality disclosed in connection with FIG. 1 may be combined with any of the other structure and functionality disclosed in connection with FIGS. 2 to 9.

In light of the present disclosure and the above aspects, it is therefore an advantage of the present disclosure to provide a respirator mask that improves air flow for a wearer and prevents an accumulation of sweat and moisture.

It is another advantage of the present disclosure to provide a respirator mask with disposable or removable filter media to extend usage without degrading air flow filtering and performance.

It is a further advantage of the present disclosure to provide a respirator mask that is comfortable to wear, thereby reducing a number of times a wearer inadvertently touches or adjusts the mask.

It is still another advantage of the present disclosure to provide a respirator mask with identical inhalation and exhalation assemblies to enable one type of filter media to be used.

It is still a further advantage of the present disclosure to provide a respirator mask with a downward facing exhalation filter assembly to enable moisture, sweat, and exhaled air to flow downward out of the mask.

It is still a further advantage of the present disclosure to provide a respirator mask that enables a wearer to mix-and-match filter types and sizes for inhalation and exhalation based on an end-use application.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a perspective view of a respirator mask, according to an example embodiment of the present disclosure.

FIG. 2 is a front view of the respiration mask of FIG. 1, according to an example embodiment of the present disclosure.

FIG. 3 is a rear view of the respiration mask of FIGS. 1 and 2, according to an example embodiment of the present disclosure.

FIG. 4 is a side view of the respiration mask of FIGS. 1 to 3, according to an example embodiment of the present disclosure.

FIG. 5 is a diagram of an example strap that may be connected to the respirator mask of FIGS. 1 to 4, according to an example embodiment of the present disclosure.

FIG. 6 is a top-down view of the respiration mask of FIGS. 1 to 4, according to an example embodiment of the present disclosure.

FIG. 7 is a bottom-up view of the respiration mask of FIGS. 1 to 4, according to an example embodiment of the present disclosure.

FIG. 8 is a perspective view of the respirator mask of FIGS. 1 to 4, according to an example embodiment of the present disclosure.

FIG. 9 is a rear view of the respirator mask of FIGS. 1 to 4, according to an example embodiment of the present disclosure.

### DETAILED DESCRIPTION

A respirator mask is disclosed herein. The example respirator mask is configured to improve air flow around a wearer's face, thereby reducing moisture and heat accumulation and improving comfort. The respirator mask includes three filter assemblies for enclosing a same type or different types/sizes of filter media. The filter assemblies may be opened, enabling disposable filter media to be replaced or non-disposable filter media to be cleaned. The use of disposable or removable filter media enable the respirator mask to operate at a high level for long-use durations to provide air filtering without degrading air flow.

As disclosed herein, the respirator mask is configurable based on a particular application and/or environment. For example, the respirator mask accepts different types and/or sizes filter media for medical applications, construction applications, manufacturing applications, etc. Representative configurations of the respiration mask include use in sterile fields and non-sterile fields. It should be appreciated that the disclosed respirator mask may be used in any application in which air filtering is needed.

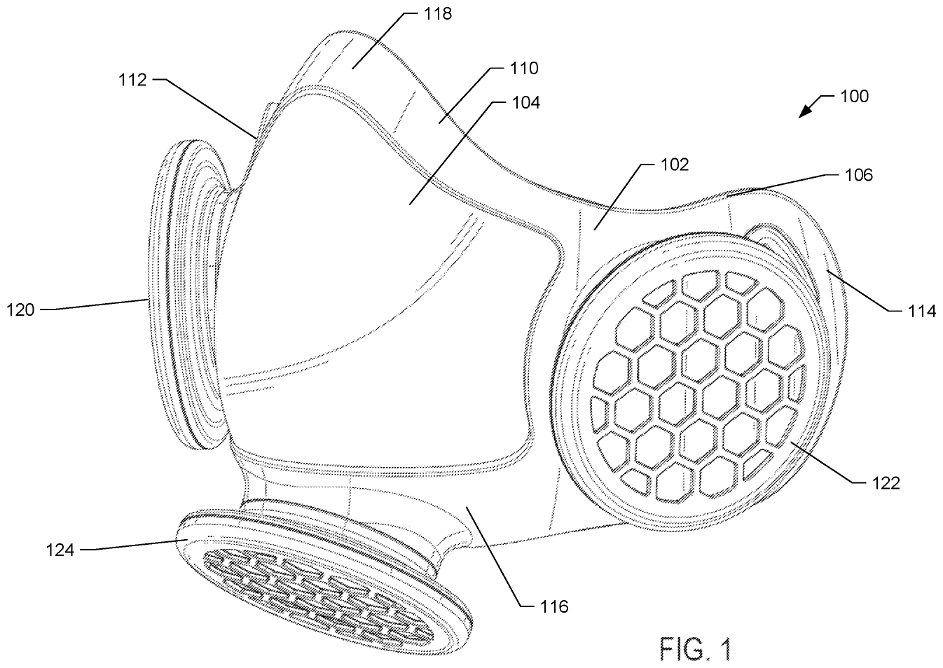

FIG. 1 is a diagram of a respirator mask 100, according to an example embodiment of the present disclosure. The respirator mask 100 includes a frame 102 that supports a transparent lens 104. In some embodiments, the lens 104 may be connected to the frame 102. In other embodiments, the lens 104 may be integrally formed with the frame 102. Further, the frame 102 may be transparent or opaque. The lens 104 is configured to be clear to enable other individuals to view facial expressions or mouth movement of a wearer. The frame 102 and/or the transparent lens 104 may include plastic, transparent plastic, glass, plexiglass, rubber or other elastomeric material, or combinations thereof.

In some embodiments, an elastomeric lip 106 is connected to or integrally formed with the frame 104. The elastomeric lip 106 is placed around a perimeter of the frame 104 and is configured to provide an air seal when pressed against a face of a wearer. The elastomeric lip 106 may be permanently connected to the frame 104 or detachable for cleaning/replacement. In some instances, the elastomeric lip 106 may be three-dimensionally printed to conform to a scan of a wearer's face.

In the illustrated example, the frame 102 includes a top section 110, a left section 112, a right section 114, and a bottom section 116. The top section 110 of the frame 102 includes a nose bridge 118 and is connected to the left section 112 and the right section 114. The nose bridge 118 includes an arch that is configured to receive and/or contact a wearer's nose. The left section 112 and the right section 114 curve inward towards a wearer's face and are configured to contact or be adjacent to a wearer's cheeks. The left section 112 and the right section 114 each include at least one aperture or cutout to enable air to pass through.

The bottom section 116 of the frame 102 is connected to the left section 112 and the right section 114. The bottom section 116 includes a protrusion to accommodate or otherwise provide for placement at a wearer's chin. The bottom section 114 also includes at least one aperture to enable air to pass through.

As shown, a perimeter of the frame 102 extends from a bridge of a wearer's nose to their cheek bones and below their chin. The frame 102 is below the wearer's eyes to provide unrestricted visibility. In another embodiment, the top section 110 of the frame 102 extends to a wearer's forehead to provide a full-face respirator.

FIG. 1 also shows that the respirator mask 100 includes a first inhalation filter assembly 120 that is connected to an external side of the left section 112 to enclose the at least one aperture. The respirator mask 100 also includes a second inhalation filter assembly 122 connected to an external side of the right section 114 to enclose the at least one aperture. Further, the respirator mask 100 includes an exhalation filter assembly 124 connected to an external side of the bottom section 116 to enclose the at least one aperture.

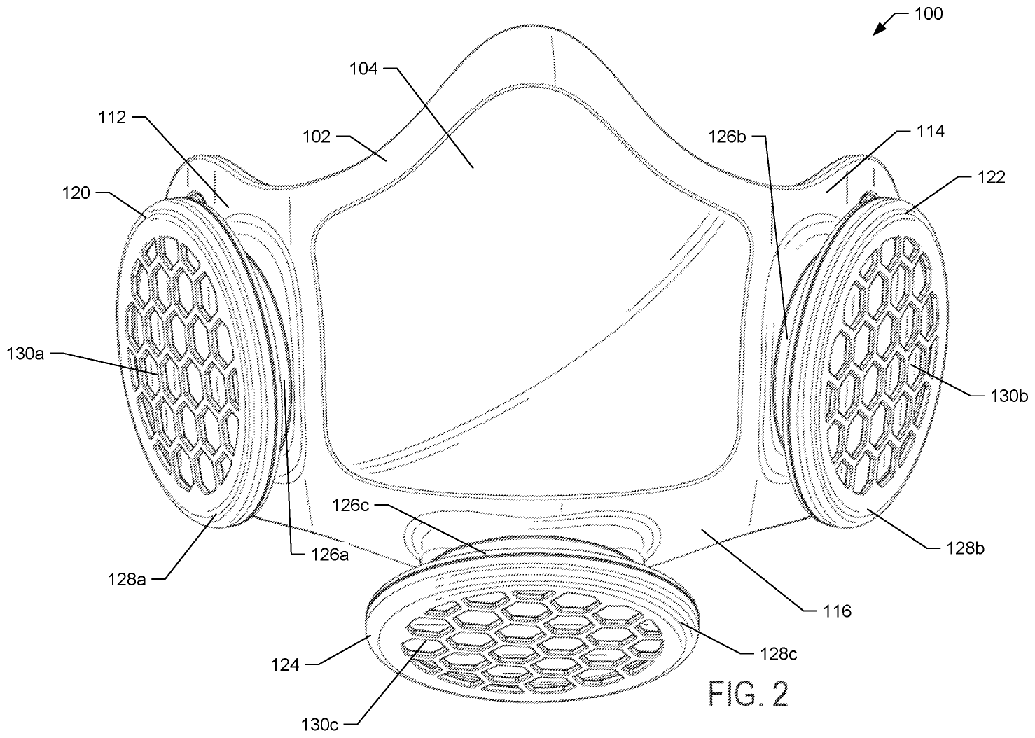

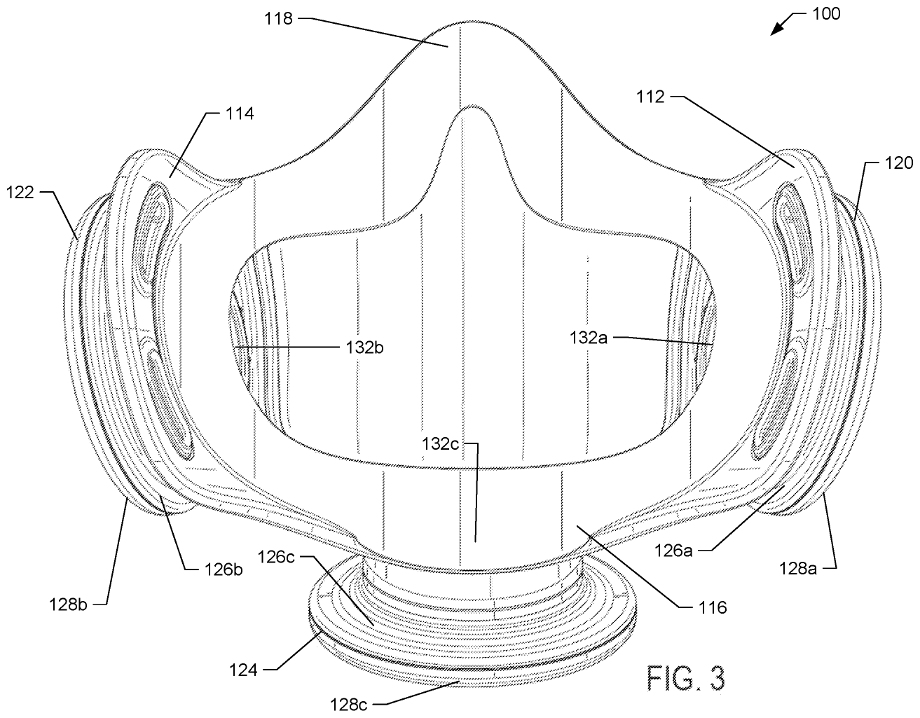

The filter assemblies 120 to 124 are more readily visible in FIGS. 2 and 3, which respective show a front view and a rear view of the respirator mask 100 of FIG. 1, according to an example embodiment of the present disclosure. As shown, each of the filter assemblies 120 to 124 includes a base section (shown respective as base sections 126a, 126b, and 126c) that connects to a respective section 112, 114, and 116 of the frame 102. The base sections 126a, 126b, and 126c are configured to cover or otherwise enclose the apertures of the respective sections 112, 114, and 116 of the frame 102.

In an embodiment, each of the base sections 126a, 126b, 126c includes a gland. In this embodiment, the sections 112, 114, and 116 includes an elastomeric sleeve. The base sections 126a, 126b, 126c are attached and sealed to the frame 102 by stretching the elastomeric sleeve over and around the respective glands.

In another embodiment, the base sections 126a, 126b, and 126c are threaded. Additionally, the sections 112, 114, and 116 each include a locking ring to contain the mating thread for securement to the threads of the base sections 126a, 126b, and 126c. The sections 112, 114, and 116 may include a gasket at the connection point to create an air-tight seal. It should be appreciated that other components may be used, such as chemical adhesives, to connect the base sections 126a, 126b, and 126c to the respective sections 112, 114, and 116 of the frame 102.

The filter assemblies 120, 122, and 124 also each include a filter cap (shown respective as filter caps 128a, 128b, and 128c). The filter caps 128a, 128b, and 128c are removably connected to the respective base sections 126a, 126b, and 126c. In some embodiments, the filter caps 128a, 128b, and 128c may be connected via screw threads or a snap connector to the respective base sections 126a, 126b, and 126c.

The filter caps 128a, 128b, and 128c are configured to retain a respective filter media 130a, 130b, and 130c against the base sections 126a, 126b, and 126c. In other words, the filter caps 128 and base sections 126 sandwich a respective filter media 130. The base sections 126 may include a recess to accept or receive the filter media 130, which is held in place by the filter cap 128.

In the illustrated embodiments, the filter caps 128 have an open honeycomb pattern to enable air and/or moisture to pass through. In other embodiments, the filter caps 128 may have other patterned openings to enable air to pass through while retaining the filter media 130 in place. For example, the filter caps 128 may have circular openings, triangular openings, square openings, a grid, a decorative pattern such as a company logo, etc.

The filter media 130 may include industrial-grade N95 filter media. In other embodiments, the filter media 130 includes P100 filter media to enable the respirator mask 100 to provide protection against smoke and oil-based particulates, such as during wildfire season. In yet other embodiments, the filter media 130 may have another rating based on an end-use application.

Known filter media, such as traditional N95 filters, utilize multiple layers (often six or more) of increasingly fine filtration to capture particulates ranging from coal dust to virus-laden microdroplets less than 100th of a millimeter in size with two outside layers to provide structural support and, optionally, a splash barrier. Each additional layer of filtration increases breathing resistance and pressure loss. However, purely for purposes of pandemic protection, the layers of filtration for the larger particulates (like coal and saw dust) provide no benefit. Including these layers in the known filter media decreases air flow and increases heat and humidity for a wearer, which in turn increases the likelihood that a wearer will engage in non-compliant behavior, such as momentarily lifting the respirator mask to breath without restriction. In some instances, the filter media 130 includes three layers. A first two outer layers are configured to provide structural support and, optionally, a splash barrier. A third inner layer is configured to provide viral and bacterial filtration. The use of fewer layers compared to known filter media decreases breathing resistance and pressure loss while providing substantial filtration protection.

The filter media 130 may include pleats, similar to that of an air-conditioner filter, to create more surface area to help promote air flow. The filter media 130 may have a circular shape corresponding to the filter assemblies 120, 122, and 124. Alternatively, the filter media 130 may have a bulbous shape to increase a filtration surface area. In some embodiments, a shape of the filter media 130 channels accumulated moisture to a base of the respective filter assembly 120, 122, and 124.

In some embodiments, an elastomeric grommet is connected to a perimeter of the filter media 130. The elastomeric grommet helps ensure an air seal within the filter assemblies 120, 122, and 124. The grommet may be removably connected to the filter media 130 to enable replacement. In some instances, the grommet may be integrally formed or connected to the base section 126. In these instances, the grommet may connect to or otherwise form a seal with the base section 126 when the filter cap 128 is connected. The grommet may provide structural rigidity for the filter media 130.

In some embodiments, the filter assemblies 120, 122, and 124 may be omitted. Instead, a grommet and filter media 130 may be inserted into the one or more apertures of the sections 112, 114, and 116 of the frame 102. For example, the grommet may be press-fittingly inserted into the apertures of the frame 102. The apertures may include a structure that mates with the grommet to form an air-tight seal. In an example, the grommet may include a groove or channel around an external face. An edge of the aperture of the frame 102 is sized to fit within the groove of the grommet to secure the filter media 130 to the frame. In another example, the grommet may include a groove or channel around an internal face. An edge of the aperture of the frame 102 is sized and curved outward to fit within the groove of the grommet to secure the filter media 130 to the frame 102.

In the illustrated example, a center or near-center of the filter media 130 is configured to be aligned with the one or more apertures of the sections 112, 114, and 116 of the frame 102. This configuration forces inhaled air to pass through the filter media 130a and 130b before entering an inside of the respirator mask 100. This configuration also forces exhaled air to pass through the filter media 130c to exit the respirator mask 100.

The filter media 130 may be disposable. In these embodiments, the filter media 130 may be periodically replaced to ensure normal air flow and particle entrapment. Alternatively, the filter media 130 may be removable for cleaning and reinstalled. Further, the removability of the filter media 130 enables a wearer to adapt the respirator mask 100 for different end-user applications by installing different types of filter media 130.

FIGS. 1 to 3 show the filter assemblies 120, 122, and 124 as having a circular shape. In other embodiments, the filter assemblies 120, 122, and 124 may have other shapes. For example, the filter assemblies may have ovular shapes, rectangular shapes, triangular shapes, pentagonal shapes, etc.

In some embodiments, the filter assemblies 120, 122, and 124 include a respective check valve 132a, 132b, and 132c. The inhalation filter assemblies 120 and 122 may include a first check valve 132a and 132b that is configured to provide one-way air communication into the respirator mask 100. Further, the exhalation filter assembly 124 may include a second check valve 132c that provides one-way air communication out of the respirator mask 100.

The first check valves 132a and 132b are configured to remain in an open state when a wearer draws a breath, pulling air into the respirator mask 100. The first check valves 132a and 132b are configured to close when the wearer exhales. The second check valve 123c is configured to remain in a closed state when a wearer draws a breath. Additionally, the second check valve 132c is configured to open when the wearer exhales enabling air and moisture to exit the respirator mask 100.

As shown in FIG. 3, the check valve 132c for exhalation is located outside of the respirator mask 100 between the respective filter media 130 and the respective base section 126. Additionally, the check valve 132a and 132b for inhalation are located on an opposite side of the base section 126a and 126b and face the inside the respirator mask 100. In some embodiments, the check valves 132 may be integrally formed into or otherwise connected to the apertures of the respective sections 112, 114, and 116 of the frame 102. Alternatively, the check valves 132 may be integrally formed into or otherwise connected to the base sections 126 of the filter assemblies 126a, 126b, and 126c. In yet alternative embodiments, the check valves 132 may be integrated with the filter media 130.

The check valves 132 may be permanently connected or may be removable. Further, in some embodiments, the check valves 132 may have a mushroom shape to provide for a one-way flow of air. Moreover, the check valves 132 may be closed or partially closed by (i) rotating a portion of a valve housing, (ii) pushing down a cap with a living hinge to seal a top of the valve, or (iii) pressing the valve body down into its housing, which closes a gap through which air communicates. In addition to above, the check valves 132 may be reversible to change a direction of air flow. The reversible nature of the check valves 132 (and positioning related to the base section 126) enables any of the assemblies 120, 122, and 124 to be easily switched between inhalation and exhalation.

While reference is made to check valves 132, it should be appreciated that any type of valve may be used. For example, the valves may include a diaphragm or membrane valve. In other embodiments, the valves may include solenoid valves or any other type of air valve. Further, an actuator on the valve is configured to actuate at pressures associated with inhaling and exhaling so as to not increase air-flow resistance for a wearer.

It should be appreciated that the base sections 126a, 126b, and 126c of the filter assemblies 120, 122, and 124 have the same or similar shapes and dimensions at a point of connection with the respective sections 112, 114, and 116 of the frame 102. The similarity of the base sections 126a, 126b, and 126 enables mixing and matching of the filter media 130. Such a configuration also enables a position of the check valves 132 to be reversed to enable exhaled air to be provided through the assemblies 120 and 122 while inhaled air is pulled through the assembly 124.

As shown in FIGS. 1 to 3, the inhalation filter assemblies 120 and 122 are located on the frame 102 above each cheek of a wearer. This positioning enables inhaled air to flow across the wearer's cheeks to their nose and mouth. This air flow across their face cools, dehumidifies, and removes excess moisture.

Additionally, the exhalation filter assembly 124 is located on the frame 102 at or near the chin of a wearer. The positioning of the exhalation filter assembly 124 at the chin pushes exhaled air downward, thereby reducing the distribution of the air after it leaves the respirator mask 100. This downward (rather than forward) direction for exhaling air reduces possible contamination and exposure of others in the event the wearer has a virus or respiratory infection. Further, the shape of the bottom 116 of the frame 102 is configured to channel moisture to the exhalation filter assembly 124. The accumulated moisture may then be pulled by gravity and/or pushed by exhaled air through the check valve 132c and out of the respirator mask 100.

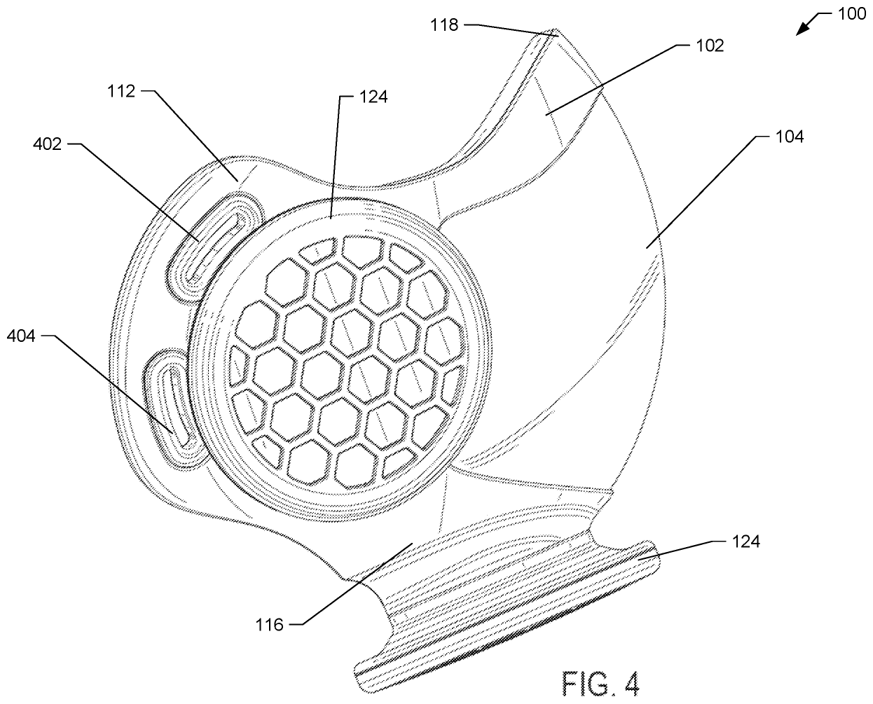

In some embodiments, the frame 102 forms a solid surface that follows the complex curves that compose a wearer's face. As shown in FIGS. 1 to 3, the frame 102 protrudes furthest from the nose and mouth of a wearer. In some embodiments, to maximize surface area, the transparent lens 104 (supported by the frame 102) is configured to protrude in a bulbous manner from the wearer's face. FIG. 4 is a side view of the respiration mask 100 of FIGS. 1 to 3, according to an example embodiment of the present disclosure. As shown, the frame 102 and lens 104 protrude away from a wearer's nose and mouth, providing additional volume for air movement. Further, any moisture that accumulates on the lens 104 is located away from the wearer and directed to flow to the exhalation filter assembly 124.

FIG. 4 also shows that the sections 112 and 114 of the frame 102 may include slots 402 and 404 for receiving one or more straps. While two slots 402 and 404 are shown, it should be appreciated that the sections 112 and 114 may omit slots, may include a single slot, or may include additional slots. Moreover, the slots 402 and 404 may be formed from one or more plastic parts connected to (by overmolding, for example) the frame 102 to provide additional resistance against friction from the straps. The straps that are received in the slots 402 and 404 are configured to secure the respirator mask 100 to a head of a wearer.

In an example, a strap for the lower slot 404 travels under a wearer's ear to a back of their neck. Additionally, a strap for the upper slot 402 travels above a wearer's ear to a top-rear corner of their head. The upper strap may split into two or more segments at the top-rear corner of the wearer's head. One or more of these segments are located at the rear of the head and one or more these segments are located at the top of the head. Together, the segments may form a harness that distributes pressure over a wider area and helps to secure the respirator mask 100 from multiple directions. Alternatively, the upper strap may attach to a plastic headgear with a preformed split that performs a weight distribution function.

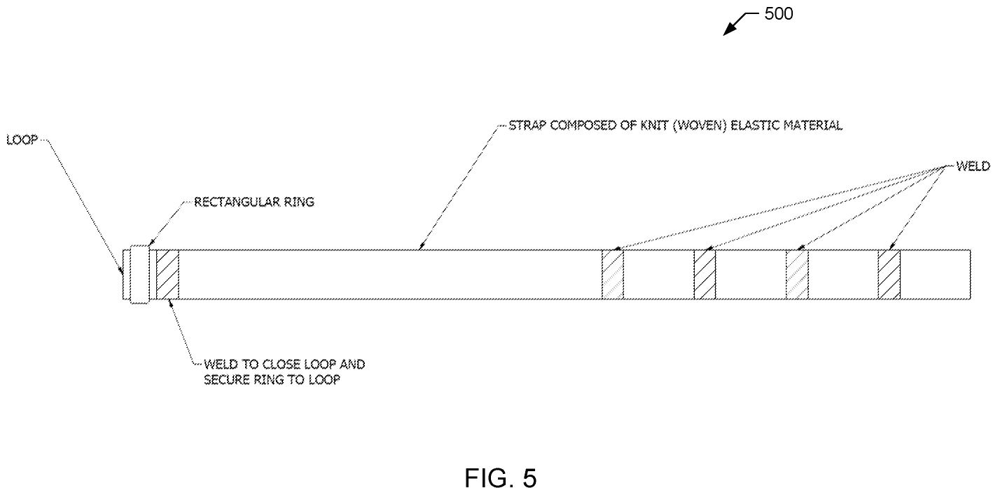

FIG. 5 is a diagram of an example strap 500 that may be looped through the slots 402 or 404 of FIG. 4, according to an example embodiment of the present disclosure. The strap 500 may include a knit elastic material and include a rectangular ring (or similar part) for length/tension/fit adjustment. The strap 500 may include one or more ultrasonic welds that enable excess sections of the strap to be easily removed. In other embodiments, the ultrasonic welds may be omitted. In some instances, a lower strap may include a quick release that enables a wearer to temporarily flip the respirator mask 100 up on their head to, for example, quickly drink water before resuming work.

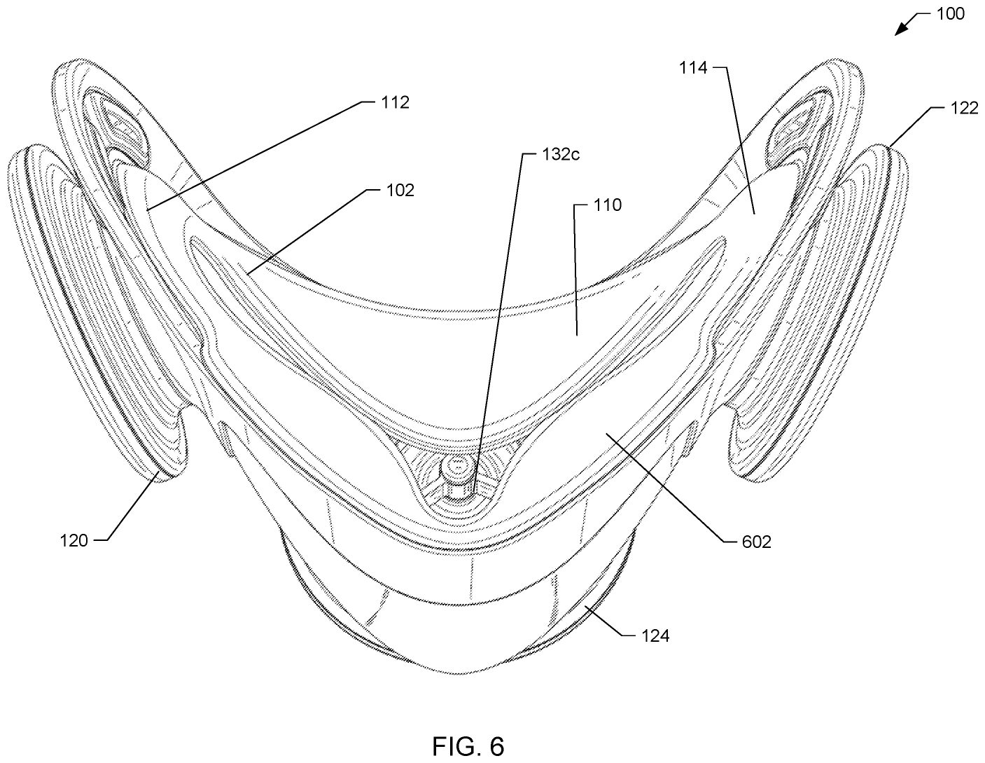

FIG. 6 is a diagram of a top-down view of the respirator mask 100 of FIGS. 1 to 4, according to an example embodiment of the present disclosure. This perspective shows a clearer view of the check valve 132c of the exhalation filter assembly 124. FIG. 6 also shows in some embodiments, the frame 102 may include at least on point of attachment 602 for a splash guard. In some embodiments, the splash guard may be integrally formed with the frame 102. Further, the filter assemblies 120, 124, and 126 may each include an attachment point for a splash guard to cover the filter media 130.

In some embodiments, the frame 102 may include an attachment point for a wireless microphone, or include a wireless microphone. In this embodiment, a wearer may use a speakerphone on a smartphone to broadcast their speech. The point of attachment may be located inside the frame 102 and out of a line of sight of the wearer.

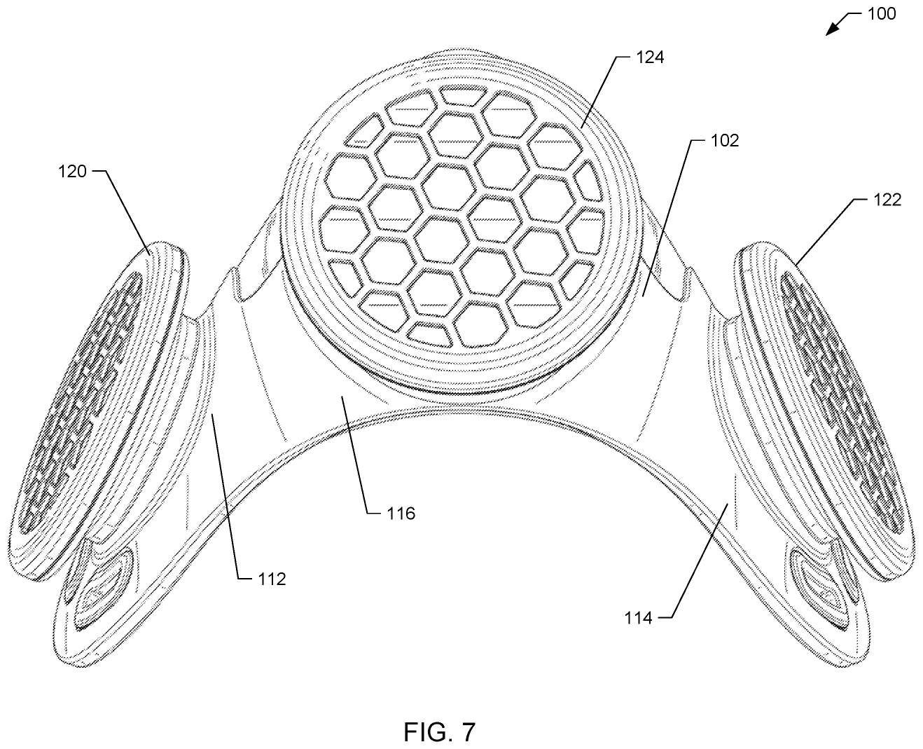

FIG. 7 is a bottom-up view of the respirator mask 100 of FIGS. 1 to 4, according to an example embodiment of the present disclosure. Fig, 7 shows how the exhalation filter assembly 124 is configured to point downward. This downward direction causes exhaled air and moisture to flow downward out of the respirator mask 100 to prevent widespread dispersion. The illustration also shows how the filter assemblies 120, 122, and 124 are connected to the frame 102 at the respective sections 112, 114, and 116.

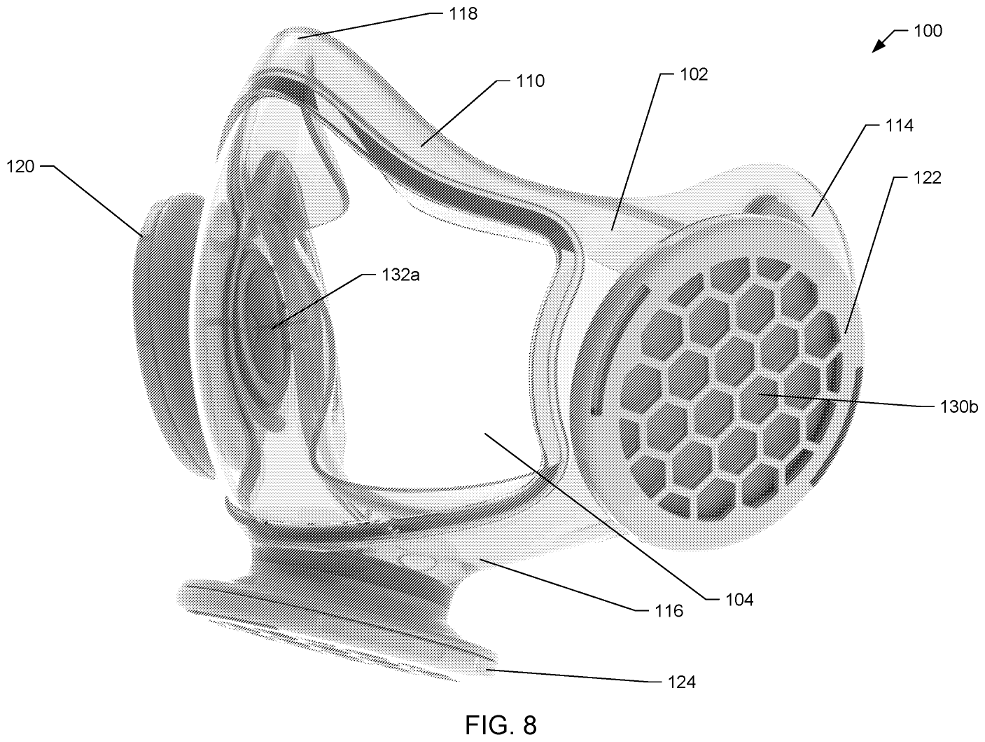

FIG. 8 is a perspective view of the respirator mask 100 of FIGS. 1 to 4, according to an example embodiment of the present disclosure. The illustrated embodiment shows one example of the check valve 132a for the inhalation filter assembly 120. The illustrated embodiment also shows that the frame 102 is transparent. In some instances, the frame 102 may include a ring of biomedical compatible plastic that conforms to the complex curves of a wearer's face. Alternatively, a portion or all of the frame 102 is coated with a biocompatible elastomeric material. The slots 402 and 404 for the straps may also be coated with the biocompatible elastomeric materials to secure the straps near the rear of the frame 102. To absorb wear, in an embodiment the slots 402 and 404 may be manufactured from plastic and designed “proud,” which is to say that the edges of the material protrude beyond the surface of the underlying frame 102 in order to lift the straps away from the softer material of the frame 102.

Further, the transparent lens 104 may be comprised of a biocompatible material that enables a wearer to write and draw on it with an erasable marker and to later erase those markings in favor of new markings. The transparent lens 104 may be thin enough that a wearer's voice communicates through the material to the ears of others with minimal distortion and decibel loss. The transparent lens 104, for example, may have a thickness of less than 3 mm, preferably around 1 mm. The thinness of the lens 104 minimizes distortion and decibel loss. The lens 104, in some embodiments, may include two parallel lenses with an air gap there between, with the second lens closest to a wearer either a duplicate of the first lens 104 or, alternately, a smaller version of the first lens 104 designed to only cover the area most prone to fogging.

In a further example, the transparent lens 104 contains Acoustic Resonant Micro-Surfaces (ARMS) that reduce distortion and decibel loss. In an example, the ARMS include a plurality of grooves in the lens 104 that create a set of surfaces parallel to the face of the wearer and someone standing directly in front of the wearer. In an example, a plurality of grooves has a uniform in length, of 21.5 mm that are organized in either horizontal or vertical parallel lines. In other embodiments, a plurality of grooves are organized in horizontal lines of various lengths in the portion of the lens 104 in front of the wearer's mouth, ideally with the following values—11:13.8:15.2:17.1:21.5:34:38:43:38:34:21.5:17.1:15.2:13.8:11 as measured in millimeters.

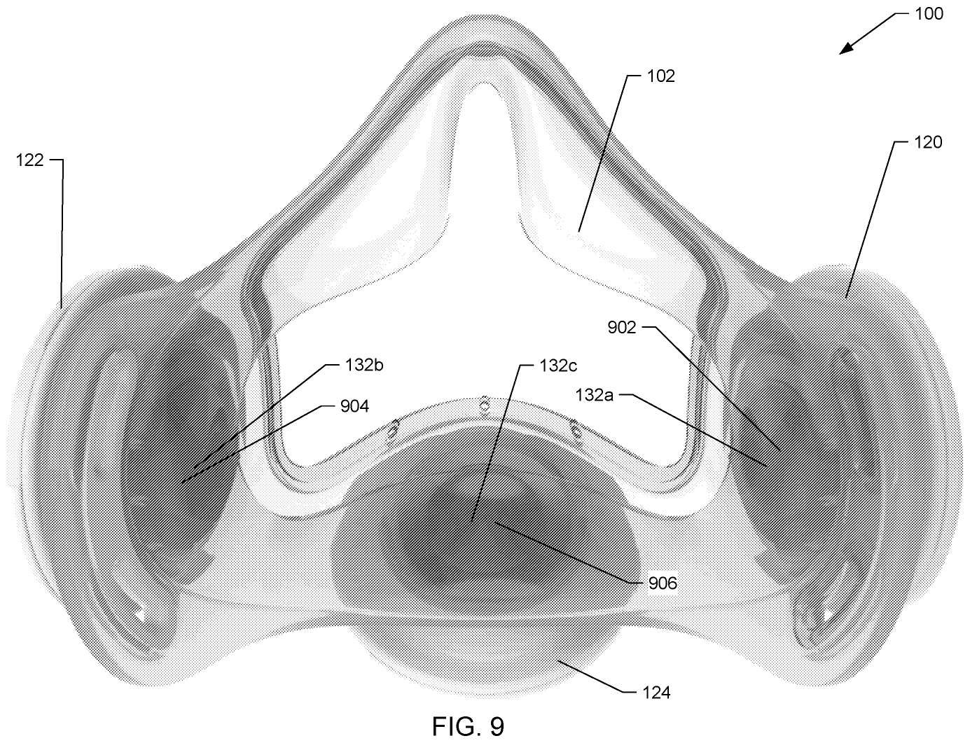

FIG. 9 is a rear view of the respirator mask 100 of FIGS. 1 to 4, according to an example embodiment of the present disclosure. The illustrated example shows a clearer view of the check valves 132a, 132b, and 132c of the respective filter assemblies 120, 122, and 124. FIG. 9 also shows corresponding apertures 902, 904, and 906 of the respective sections 112, 114, and 116 of the frame 102. As shown, the apertures 902, 904, and 906 are aligned with the check valves 132a, 132b, and 132c to provide for one-way air flow into or out of the respirator mask 100.

As shown in FIG. 9, the materials of the respirator mask 100 may be cleaned and/or sterilized by running through a dishwasher on a hot cycle. Further, a shape of the frame 102 and/or lens 104 and corresponding points of attachment lack any crevices or small areas that would prove difficult to reach in a liquid bath or would otherwise provide surfaces difficult to clean and sterilized by approved methods. The disclosed respirator mask 100 accordingly is easy to maintain and clean, thereby extending its useful life.

The respirator mask 100 could be configured to replace one or more of the inhalation filter assembly 120 and 122 and the exhalation filter assembly 124 with adapters that enable a wearer to use the broad array of specialty filters from 3M®, Honeywell®, and other manufacturers. Doing so provides a wearer with both greater breadth of filter offerings and a deeper, more redundant supply chain during a time of emergency.

### Filter Media Interchangeability Embodiment

As described above, the filter assemblies 120, 122, and 124 include the filter media 130. The base sections 126 and the filter caps 128 are configured to receive or house filter media 130 of different sizes. For example, the base sections 126 and the filter caps 128 may house circular filter media 130 having a diameter between 30 mm and 200 mm. It should be appreciated that the filter assemblies 120, 122, and 124 are configured to enable a wearer to mix-and-match different filter media 130 based on an end-use application or personal preference. For example, a wearer may select two 120 mm inhale filters and one 60 mm or 80 mm exhale filter for a dusty environment. In another example, a wearer may select two 60 mm inhalation filter media 130 and one 80 mm filter media 130 for exhaling. The possible filter media 130 combinations are virtually endless.

In a further example, the filter assemblies 120, 122, and 124 are produced in various sizes and can be changed out depending on the present need of a wearer. In an example, the base section 126 and the filter cap 128 are designed to support a smaller replaceable filter media (60 mm for example) suitable for pathogenic protection during light-duty, non-aerobic tasks, such as indoor office work, teaching in a classroom, or running errands. In an alternate example, the base section 126 and the filter cap 128 are designed to support a larger replaceable filter media (80, 120, and 150 mm for example) that are sufficient for heavier-duty, more aerobic activity, such as jogging or spending extended periods in a smoke-filled outdoor environment.

In some embodiments, at least one of the filter assemblies 120, 122, and 124 may be removed. A third-party filter assembly or a third-party filter media may instead be connected to the respective section 112, 114, or 116 of the frame 102. In some embodiments, an adapter may be used to facilitate the connection between the section 112, 114, or 116 of the frame 102 and the third-party filter assembly and/or filter media.

### Powered Respirator Mask Field Embodiment

In some embodiments, the respirator mask 100 may be used as a Powered Air Purifying Respirator (PAPR). In these embodiments, the filter assemblies 120, 122, and 124 may be replaced by a powered fan/filter assembly. In some embodiments, the base sections 126 may remain in place and a fan/filter assembly may replace the filter cap 128 and the filter media 130. A power source for the fan may be integrated into the cap or located on a user and connected via wired connection. In some instances, the wires may be integrated with the strap 500 to minimize clutter and entanglement.

The PAPR helps create a sterile environment inside the respirator mask 100 even if the mask fits poorly or at least is poorly situated by an inexpert wearer. The disclosed respirator mask 100 would be useful in environments that contain an airborne pathogen that is highly contagious (like measles) and highly deadly (like MERS).

### Conclusion

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A respirator mask apparatus comprising:
a transparent lens integrated with a transparent frame, the transparent frame including:
a top section including a nose bridge to contact a wearer's nose,
left and right sections respectively connected to the top section to contact the wearer's checks, each of the left and right sections including at least one aperture,
a bottom section including a protrusion to contact the wearer's chin and at least one aperture, and
an elastomeric lip around a perimeter of the transparent frame configured to provide an air seal with a face of the wearer;
a first inhalation filter assembly connected to an external side of the left section to enclose the at least one aperture;
a second inhalation filter assembly connected to an external side of the right section to enclose the at least one aperture; and
an exhalation filter assembly connected to an external side of the bottom section to enclose the at least one aperture.

2. The apparatus of claim 1, wherein each of the first and second inhalation filter assemblies and the exhalation filter assembly include:
filter media;
a base section configured to receive the filter media; and
a filter cap removably connected to the base section to retain the filter media against the base section.

3. The apparatus of claim 2, wherein each of the first and second inhalation filter assemblies includes a first check valve facing an inside of the apparatus or integrated with the base section of the respective filter assembly or the respective left or right section, the check valve configured to enable one-way air communication into the apparatus.

4. The apparatus of claim 3, wherein the exhalation filter assembly includes a second check valve located between the filter media and the bottom section of the frame or integrated with the base section of the exhalation filter assembly or the bottom section of the frame, the check valve configured to enable one-way air communication out of the apparatus.

5. The apparatus of claim 4, wherein the first and second check valves are reversible or adjustable to change an air-flow direction or air-flow resistance.

6. The apparatus of claim 2, wherein the filter cap has at least one opening to enable air to pass through to the filter media.

7. The apparatus of claim 2, wherein each of the filter assemblies are configured to accept different types or sizes of filter media.

8. The apparatus of claim 7, wherein a first type or size of filter media are used with the first and second inhalation filter assemblies and a second type or size of filter media is used with the exhalation filter assembly.

9. The apparatus of claim 2, wherein the filter media includes two outer layers configured for structural support and a third inner layer configured for viral and bacterial filtration.

10. The apparatus of claim 1, wherein at least one of the filter assemblies is replaced by an adaptor that facilitates a connection to at least one of a third-party filter media or a third-party filter assembly.

11. The apparatus of claim 1, wherein the positioning of the exhalation filter assembly is configured to enable accumulated moisture and sweat to flow downward out of an inside of the apparatus and enable exhaled air to flow downward preventing external contamination of others.

12. The apparatus of claim 1, wherein the transparent lens has a bulbous shape configured to prevent contact between lips and the nose of the wearer.

13. The apparatus of claim 1, wherein the transparent lens includes at least one of dual parallel lenses with an air gap between the lenses or dual parallel lenses with a second lens including a mini-lens located inside of the apparatus.

14. The apparatus of claim 1, wherein the transparent lens has a thickness that is less than 3.0 mm to minimize vocal distortion and decibel loss.

15. The apparatus of claim 1, wherein the transparent lens contains Acoustic Resonant Micro-Surfaces (“ARMS”) that reduce distortion and decibel loss.

16. The apparatus of claim 1, wherein the first inhalation filter assembly is positioned at the left section and the second inhalation filter assembly is positioned at the right section to enable inhaled air to pass over and cool the wearer's face.

17. The apparatus of claim 1, wherein each of the left and right sections includes at least one harness slot to receive a strap of a harness.

18. The apparatus of claim 1, wherein the strap includes ultrasonic welds to enable unused portions of the strap to be removed.

19. The apparatus of claim 1, wherein base sections of the first inhalation filter assembly, the second inhalation filter assembly, and the exhalation filter assembly have the same dimensions to enable interchangeability or removal of check valves.

20. The apparatus of claim 1, wherein the top section is configured to sit below a wearer's eyewear.

21. A respirator mask apparatus comprising:
a transparent lens integrated with a frame, the frame including:
a top section including a nose bridge to contact a wearer's nose,
left and right sections respectively connected to the top section to contact the wearer's checks, each of the left and right sections including at least one aperture, and
a bottom section including a protrusion to contact the wearer's chin and at least one aperture;
a first inhalation filter assembly connected to an external side of the left section to enclose the at least one aperture;
a second inhalation filter assembly connected to an external side of the right section to enclose the at least one aperture; and
an exhalation filter assembly connected to an external side of the bottom section to enclose the at least one aperture,
wherein each of the first and second inhalation filter assemblies and the exhalation filter assembly include:
filter media,
a base section configured to receive the filter media,
a filter cap removably connected to the base section to retain the filter media against the base section, and
a check valve located between the filter media and the base section or integrated with the base section.
